(19) United States
(12) Patent Application Publication
(10) Pub. No.: US 2025/0257530 A1
(43) Pub. Date: Aug. 14, 2025

(54) RACETRACK OVAL PAPERBOARD PRODUCTS WITH IMPROVED RIGIDITY AND MOISTURE BARRIER PROPERTIES

(71) Applicant: Hoffmaster Group, Inc., Clintonville, WI (US)

(72) Inventors: Mark HUNTER, Green Bay, WI (US); Jason LAATSCH, Shawano, WI (US); Joe SOMMERS, Pulaski, WI (US); Chad ROBENHORST, Appleton, WI (US); Kyle MILLER, Hobart, WI (US); Randy DeCOSTER, Gillett, WI (US); Chad HILDEBRANDT, Greenville, WI (US); Breanna VAN NULAND, Oconto, WI (US); Laura SCHWIND, Indianapolis, IN (US); Sarah MILLIES, Georgetown, WI (US)

(73) Assignee: Hoffmaster Group, Inc., Clintonville, WI (US)

(21) Appl. No.: 19/051,330

(22) Filed: Feb. 12, 2025

Related U.S. Application Data
(60) Provisional application No. 63/552,583, filed on Feb. 12, 2024.

(51) Int. Cl. D21J 1/16; D21H 17/28

(52) U.S. Cl. CPC D21J 1/16; D21H 17/28

(57) ABSTRACT

Aspects of the present disclosure include racetrack oval paperboard products comprising two straight sidewalls parallel to one another in the longitudinal direction of the product, the racetrack oval paperboard products comprising at least one modified starch and at least one crosslinker, wherein the at least one modified starch is present in an amount ranging from 2% to 20% by weight of the oval paperboard product, wherein the at least one crosslinker is present in an amount ranging from 0.5% to 8% by weight based on the dry weight of the starch content in the oval paperboard product, and wherein the racetrack oval paperboard product has a rigidity value ranging from 375 to 500.

This application claims the benefit of priority to U.S. Provisional Application No. 63/552,583, filed Feb. 12, 2024, which is incorporated by reference in its entirety.

The present disclosure is directed to oval paperboard products with improved rigidity, durability, and moisture barrier properties. More specifically, the disclosure is directed to racetrack oval paperboard products, such as plates, platters, and trays having higher rigidity values, durability, and increased moisture barrier properties compared to conventional oval paperboard products currently on the market.

The current disclosure provides methods for increasing rigidity, durability, and moisture barrier properties through geometric design, material engineering, and/or improved processing techniques. Common to all embodiments of the present disclosure is the racetrack oval paperboard products comprising a straight sidewall in the longitudinal direction of the racetrack oval paperboard product. As used herein, a racetrack oval shape refers to a shape with two straight sides parallel to one another separated by semicircular curved ends, with the straight sides representing the longitudinal axis of the shape. In certain embodiments, the racetrack oval paperboard products comprise at least one modified starch and at least one crosslinker.

Rigidity of a paperboard product generally refers to the measure of resistance of the paperboard product to bending and/or buckling. The Foodservice Packaging Institute (FPI), a trade association that represents the foodservice packaging industry, developed its FPI rigidity test to provide a standard method of measuring the rigidity of paperboard products. FPI rigidity is measured in grams of force required to deflect the rim of a paperboard product by 0.5 inches while the paperboard product is supported at its geometric mean center.

With paperboard engineering methods, the blank's moisture venting, i.e., the vapor release rate and the uniformity of release and rate from the backside of the paper plate can be maximized, thereby preventing deformation and/or delamination of the oval blank. An oval paperboard blank moisture may range from 6% to as high as 11%. The rigidity values set forth throughout the present disclosure are determined by measuring the FPI Rigidity value of the oval paperboard product and dividing that value by the basis weight in pounds/3000 ft² ream of the oval paperboard blank, wherein the oval paperboard blank has a moisture ranging from 6% to 11%. In some embodiments, the oval paperboard blank has a moisture ranging from 8% to 10%. In certain embodiments, the oval paperboard blank has a moisture ranging from 9% to 10%. Accordingly, the rigidity values set forth in the present disclosure are normalized through this calculation.

General embodiments of the present disclosure are directed to racetrack oval paperboard products comprising two straight sidewalls parallel to one another in the longitudinal direction of the product, the racetrack oval paperboard products comprising at least one modified starch and at least one crosslinker, wherein the at least one modified starch is present in an amount ranging from 2% to 20% by weight of the oval paperboard product, wherein the at least one crosslinker is present in an amount ranging from 0.5% to 8% by weight based on the dry weight of the starch content in the oval paperboard product, and wherein the racetrack oval paperboard product has a rigidity value ranging from 375 to 500.

A further embodiment of the present disclosure is directed to a racetrack oval paperboard product comprising straight sidewalls in the longitudinal direction of the product, the racetrack oval paperboard products comprising amylopectin and at least one crosslinker, wherein the at least one amylopectin is present in an amount ranging from 2% to 20% by weight of the oval paperboard product, wherein the at least one crosslinker is present in an amount ranging from 0.5% to 8% by weight based on the dry weight of the starch content in the oval paperboard product, and wherein the oval paperboard product has a rigidity value ranging from 375 to 500.

Another embodiment of the present disclosure is directed to an oval paperboard product comprising straight sidewalls in the longitudinal direction of the product, the racetrack oval paperboard products comprising a backside additive comprising at least one modified starch and at least one crosslinker, wherein the at least one modified starch is present in an amount ranging from 2% to 20% by weight of the racetrack oval paperboard product, wherein the at least one crosslinker is present in an amount ranging from 0.5% to 8% by weight based on the dry weight of the starch content in the racetrack oval paperboard product, and wherein the paper board product has a rigidity value ranging from 375 to 500.

A further embodiment of the present disclosure is directed to a racetrack oval paperboard product comprising at least one modified starch and at least one crosslinker, wherein the racetrack oval paperboard product has a straight sidewall 2.7±0.3 inches in length, and further comprises: a substantially planar bottom region; a substantially frustoconical sidewall extending upward and outward from an outer periphery of the bottom region; an annular inner brim portion contiguous with a radially outer extent of the frustoconical sidewall; and an annular outer frustoconical brim portion contiguous with a radially outer extent of the annular inner brim portion, wherein a first arcuate portion interconnects the bottom region and a radially inner end of the frustoconical sidewall, a second arcuate portion interconnects the radially outer extent of the frustoconical sidewall and the annular inner brim portion, and a third arcuate portion interconnects the radially outer extent of the annular inner brim portion and the annular outer frustoconical brim portion, the annular outer frustoconical brim portion includes a distal concave lip portion around an outer periphery of the product, the frustoconical sidewall extends upward and outward from the bottom region at an angle of 22.0±0.5 degrees from a vertical line parallel to a central axis of the product, the annular inner brim portion slopes downward and outward from the radially outer extent of the frustoconical sidewall at an angle that is 4.0±0.5 degrees from a horizontal line parallel to the bottom region, and the annular outer frustoconical brim portion slopes downward more steeply than the downward slope of the annular inner brim portion, extending from the radially outer extent of annular inner brim portion at an angle that is 40.0±0.5 degrees from the vertical line parallel to the central axis of the product.

Another embodiment of the present disclosure is directed to a process for making a rigid racetrack oval paperboard product, the process comprising: a) providing a racetrack oval paperboard material to a die press in a plate former; b) applying pressure to the plate former in an amount ranging from four tons to eleven tons; c) applying a backside coating to the formed plate using a press coater, wherein the backside coating comprises at least one modified starch in an amount ranging from 2% to 20% by weight of the racetrack oval paperboard product, and at least one crosslinker in an amount ranging from 0.5% to 8% by weight based on the dry weight of the starch content in the racetrack oval paperboard product.

A further embodiment of the present disclosure is directed to a process for making a rigid paper plate, the process comprising: a) providing a racetrack oval paperboard material to a die press in a plate former, wherein the die press has a rim design configured to produce an racetrack-oval shaped plate comprising a substantially planar bottom region; a substantially frustoconical sidewall extending upward and outward from an outer periphery of the bottom region; an annular inner brim portion contiguous with a radially outer extent of the frustoconical sidewall; and an annular outer frustoconical brim portion contiguous with a radially outer extent of the annular inner brim portion, wherein a first arcuate portion interconnects the bottom region and a radially inner end of the frustoconical sidewall, a second arcuate portion interconnects the radially outer extent of the frustoconical sidewall and the annular inner brim portion, and a third arcuate portion interconnects the radially outer extent of the annular inner brim portion and the annular outer frustoconical brim portion, the annular outer frustoconical brim portion includes a distal concave lip portion around an outer periphery of the plate, the frustoconical sidewall extends upward and outward from the bottom region at an angle of 22.0±0.5 degrees from a vertical line parallel to a central axis of the plate, the annular inner brim portion slopes downward and outward from the radially outer extent of the frustoconical sidewall at an angle that is 4.0±0.5 degrees from a horizontal line parallel to the bottom region, and the annular outer frustoconical brim portion slopes downward more steeply than the downward slope of the annular inner brim portion, extending from the radially outer extent of annular inner brim portion at an angle that is 40.0±0.5 degrees from the vertical line parallel to the central axis of the plate; b) applying pressure to the plate former in an amount ranging from four tons to eleven tons; and c) applying a backside coating to the formed plate using a press coater, wherein the backside coating comprises at least one modified starch and at least one crosslinker.

### BRIEF DESCRIPTION OF THE DRAWINGS

FIG. 1 depicts a racetrack oval plate in accordance with the present disclosure.

FIG. 2 depicts a racetrack oval plate with gravy well in accordance with the present disclosure.

FIG. 3 depicts a cross-section of a die design for a racetrack oval plate in accordance with the present disclosure.

FIG. 4 depicts a blow-up of portion A of the die design of FIG. 3.

FIG. 5 depicts a different view of a racetrack oval plate in accordance with the present disclosure.

FIG. 6 depicts a view of another racetrack oval plate in accordance with the present disclosure.

FIG. 7 depicts a cross-sectional view of the B-B dimension of the 9.2″×12″ racetrack oval plate depicted in FIG. 6.

FIG. 8 depicts a cross-sectional view of the A-A dimension of the 9.2″×12″ racetrack oval plate depicted in FIG. 6.

FIG. 9 depicts a blow-up of portion C of the cross-sectional depicted in FIG. 8.

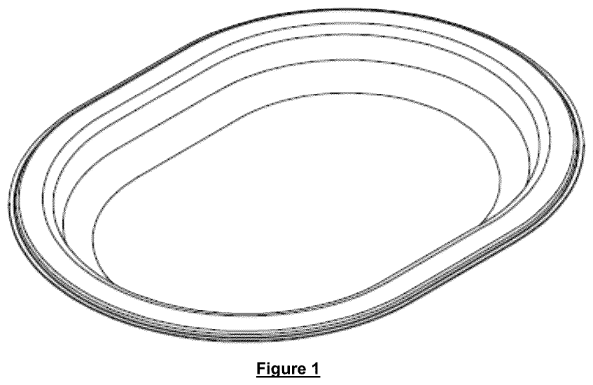

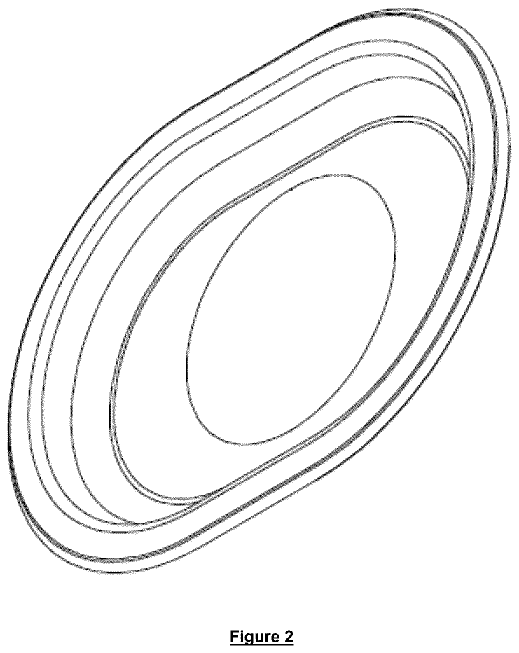

The present disclosure is directed to racetrack oval paperboard products having a major axis defining the longest diameter of the elliptically-shaped outer perimeter of the plate and going through the center of the plate from one outer peripheral edge of the plate to an opposite peripheral edge of the plate, and a minor axis perpendicular to the major axis and defining the shortest diameter of the straight-edged outer perimeter of the plate, extending through the center of the plate from another outer straight edge of the plate to an opposite and parallel straight edge of the plate. In certain embodiments, the length of the straight edge ranges from 2.5 to 3.0 inches. Non-limiting examples of the straight edge length include 2.60±0.05 inches, 2.70±0.05 inches, 2.80±0.05 inches, and 2.90±0.05 inches. In additional embodiments, the length of the straight edge, can be, for example, 2.745±0.005 inches, 2.755±0.005 inches, 2.765±0.005 inches, 2.775±0.005 inches, 2.785±0.005 inches, and 2.795±0.05 inches.

Embodiments of the present disclosure are directed to racetrack oval paperboard products having improved rigidity. In these embodiments, the rigid racetrack oval paperboard product comprises at least one modified starch and at least one crosslinker, wherein the at least one modified starch is present in an amount ranging from 2% to 20% by weight of the racetrack oval paperboard product, wherein the at least one crosslinker is present in an amount ranging from 0.5% to 8% by weight based on the dry weight of the starch content in the racetrack oval paperboard product.

A variety of racetrack oval paperboard products are contemplated in the present disclosure. Non-limiting examples of these racetrack oval paperboard products include plates, platters, and trays, such as 9′×12″ racetrack oval plates, 9.2″×12″ racetrack oval plates, 9.225″×12″ racetrack oval plates and 10″×12″ racetrack oval plates. The plates can be manufactured in a variety of thicknesses depending on the desired end use and non-limiting examples of the thickness include 12-point, 14-point, 16-point, 18-point, 20-point, 22-point, 24-point, and 28-point plates. In certain embodiments, the racetrack oval plates have a 22-point thickness. As used herein, paper thickness is measured in thousandths of an inch, referred to as “points,” and a 22-point plate, for example, will have a thickness equal to 0.022 inches.

The racetrack oval paperboard products according to the present disclosure can be made using commercially available paper stock. Non-limiting examples include paper stock available from Graphic Packaging International (GPI), such as GPI 20-point Premium platestock, which has a target basis weight of 221.5 pounds/3000 ft², GPI 24-point platestock, which has a target basis weight of 257.0 pounds/3000 ft², and Everest 28-point folding carton board, which has a target basis weight of 303.0 pounds/3000 ft². Additional non-limiting, exemplary paper stock includes 18-point Clearwater paperboard blanks, 20-point WestRock paperboard blanks, 22-point WestRock paperboard blanks, and 24-point SAPPI paperboard blanks. In certain embodiments, the basis weight of the paper stock and paperboard blanks range from 120 pounds/3000 ft² to 320 pounds/3000 ft², such as from 160 pounds/3000 ft² to 310 pounds/3000 ft², from 180 pounds/3000 ft² to 310 pounds/3000 ft², from 200 pounds/3000 ft² to 310 pounds/3000 ft², from 220 pounds/3000 ft² to 310 pounds/3000 ft², and from 140 pounds/3000 ft² to 310 pounds/3000 ft².

According to the present disclosure, the paper stock can be combined with a bleached chemi-thermomechanical pulp (BCTMP). BCTMP is a type of pulp produced through a combination of chemical and mechanical processes in which wood chips, such as hardwood and/or softwood, are subjected to both chemical and thermal treatments. The chemical treatment involves the use of sodium sulfite or sodium bisulfite to break down the lignin in the wood. The thermal treatment involves steaming the wood chips, in order to soften the wood chip and separate the wood fibers. The BCTMP can be added to a conventional paper stock pulp in order to form a homogeneous mixture, or the BCTMP can be added as a separate layer in combination with one or more layers of conventional paperstock. In some embodiments, the BCTMP layers is combined with a single layer of conventional paperstock and in other embodiments, the BCTMP layer is sandwiched between two layers of conventional paperstock.

In certain embodiments, the final paper blank, paperboard used to make the blank, and/or pulp used to make the paperboard comprises from 5 to 40% by weight BCTMP, such as, for example, from 5 to 35% by weight BCTMP, from 5 to 30% by weight BCTMP, from 5 to 35% by weight BCTMP, from 5 to 20% by weight BCTMP, from 5 to 15% by weight BCTMP, 5 to 10% by weight BCTMP, from 10 to 40% by weight BCTMP, from 10 to 35% by weight BCTMP, from 10 to 30% by weight BCTMP, from 10 to 25% by weight BCTMP, from 10 to 20% by weight BCTMP, from 15 to 40% by weight BCTMP, from 15 to 35% by weight BCTMP, from 15 to 30% by weight BCTMP, from 15 to 25% by weight BCTMP, from 20 to 40% by weight BCTMP, from 20 to 35% by weight BCTMP, from 20 to 30% by weight BCTMP, from 25 to 40% by weight BCTMP, from 25 to 35% by weight BCTMP, and from 30 to 40% by weight BCTMP.

The racetrack oval paperboard products according to the present disclosure can be press molded from a paper blank or pulp molded from a wet-processed pulp.

Non-limiting examples of suitable modified starches according to the present disclosure include ethylated starches, amylopectin starches, and combinations thereof. In certain embodiments of the present disclosure, the amylopectin starches are chosen from highly branched amylopectins. Non-limiting examples of suitable modified starches include Ingredion™ PenCote™ L800, Ingredion™ PenCote™ L1000, Ingredion™ Redifilm™ 5400, Ingredion™ Redifilm™ 5800, Ingredion™ Redifilm™ 2030, and EcoSynthetix® EcoSphere® 2330. The at least one modified starch can be present in an amount ranging from 2% to 20% dry solids by weight of the racetrack oval paperboard product, and non-limiting exemplary ranges include from 2% to 18% by weight, from 2% to 15% by weight, from 2% to 12% by weight, from 2% to 10% by weight, from 2% to 8% by weight, from 3% to 20% by weight, from 3% to 18% by weight, from 3% to 15% by weight, from 3% to 12% by weight, from 3% to 10% by weight, from 3% to 8% by weight, from 5% to 20% by weight, from 5% to 18% by weight, from 5% to 15% by weight, 5% to 12% by weight, from 5% to 10% by weight, from 5% to 8% by weight, from 7% to 20% by weight, from 7% to 18% by weight, from 7% to 15% by weight, from 7% to 12% by weight, from 7% to 10% by weight, from 10% to 20% by weight, and from 10% to 18% by weight, and from 10% to 15% by weight.

Non-limiting examples of suitable crosslinkers include glyoxal crosslinkers, potassium zirconium crosslinkers, ammonia zirconium crosslinkers, citric acid crosslinkers, and combinations thereof. In certain embodiments, the amount of glyoxal crosslinkers do not exceed 6% by weight based on the dry weight of the starch content in the racetrack oval paperboard product. Non-limiting, exemplary ranges of the amount of glyoxal crosslinker include from 0.5 to 6% dry weight of the starch, such as 0.5% to 5.5% by weight, 0.5% to 5% by weight, 0.5% to 4.5% by weight, 0.5% to 4% by weight, 0.5% to 3.5% by weight, 0.5% to 3% by weight, 0.5% to 2.5% by weight, 0.5% to 2% by weight, 1% to 5.5% by weight, 1% to 5% by weight, 1% to 4.5% by weight, 1% to 4% by weight, 1% to 3.5% by weight, 1% to 3% by weight, 1% to 2.5% by weight, 1.5% to 5.5% by weight, 1.5% to 5% by weight, 1.5% to 4.5% by weight, 1.5% to 4% by weight, 1.5% to 3.5% by weight, and 1.5% to 3% by weight. In other embodiments, the amount of the at least one zirconium and ammonia crosslinkers does not exceed 5% dry weight of the starch content in the racetrack oval paperboard product. Non-limiting, exemplary ranges of the amount of zirconium and/or ammonia crosslinkers include 0.5% to 4.5% by weight, 0.5% to 4% by weight, 0.5% to 3.5% by weight, 0.5% to 3% by weight, 0.5% to 2.5% by weight, 0.5% to 2% by weight, 0.5% to 1.5% by weight, by weight, 1% to 4.5% by weight, 1% to 4% by weight, 1% to 3.5% by weight, 1% to 3% by weight, 1% to 2.5% by weight, 1% to 2% by weight, 1.5% to 4.5% by weight, 1.5% to 4% by weight, 1.5% to 3.5% by weight, 1.5% to 3% by weight, 1.5% to 2.5% by weight, 2% to 4.5% by weight, 2% to 4% by weight, 2% to 3.5% by weight, 2% to 3% by weight, and 2% to 2.5% by weight. In some embodiments, the amount of the at least one zirconium and ammonia crosslinker does not exceed 2.5% dry weight of the starch content in the racetrack oval paperboard product.

In certain embodiments of the present disclosure, the racetrack oval paperboard product comprises at least one amylopectin and at least one crosslinker, wherein the at least one amylopectin is present in an amount ranging from 2% to 20% by weight of the racetrack oval paperboard product, and the at least one crosslinker is present in an amount ranging from 0.5% to 8% by weight based on the dry weight of the starch content in the racetrack oval paperboard product. Non-limiting examples of suitable amylopectins include PenCote™ L800, Redifilm™ 5800 and EcoSphere® 2330. Non-limiting, exemplary ranges of the amount of at least one amylopectin include from 2% to 18% by weight, from 2% to 15% by weight, from 2% to 12% by weight, from 2% to 10% by weight, from 2% to 8% by weight, from 3% to 20% by weight, from 3% to 18% by weight, from 3% to 15% by weight, from 3% to 12% by weight, from 3% to 10% by weight, from 3% to 8% by weight, from 5% to 20% by weight, from 5% to 18% by weight, from 5% to 15% by weight, 5% to 12% by weight, from 5% to 10% by weight, from 5% to 8% by weight, from 7% to 20% by weight, from 7% to 18% by weight, from 7% to 15% by weight, from 7% to 12% by weight, from 7% to 10% by weight, from 10% to 20% by weight, and from 10% to 18% by weight, and from 10% to 15% by weight. In certain embodiments, the at least one amylopectin is present in an amount ranging from 10 to 20% based on the weight of the racetrack oval paperboard product.

In further embodiments, the at least one amylopectin and the at least one crosslinker are comprised in one of the following combinations: Ingredion™ PenCote™ L800 and a glyoxal crosslinker; Ingredion™ Redifilm™ 5800 and a glyoxal crosslinker; EcoSynthetix® EcoSphere® 2330 and a glyoxal crosslinker; Ingredion™ PenCote™ L800 and a potassium zirconium crosslinker; Ingredion™ Redifilm™ 5800 and a potassium zirconium crosslinker; and EcoSynthetix® EcoSphere® 2330 and a potassium zirconium crosslinker.

In certain embodiments, the racetrack oval paperboard products according to the present disclosure have a rigidity value ranging from 350 to 500. Non-limiting, exemplary ranges include rigidity values of 375 to 500, 400 to 500, 425 to 500, 450 to 500, 475 to 500, 375 to 475, 400 to 475, 425 to 475, 450 to 475, 375 to 450, 400 to 450, 425 to 450, 375 to 425, and 400 to 425. In certain embodiments, these rigidity values are produced in paper products formed from 18-point, 20-point, 22-point, and 24-point paper stock. In a further embodiment, the racetrack oval paperboard product had a thickness of 20 pt and a rigidity ranging from 375 to 400.

Additional embodiments of the present disclosure are directed to optimizing backside additive effectiveness. In certain embodiments, the backside additive comprises a combination of at least one modified starch and at least one crosslinker, wherein the at least one modified starch is present in an amount ranging from 2% to 20% by weight of the racetrack oval paperboard product and the one crosslinker is present in an amount ranging from 0.5% to 8% by weight based on the dry weight of the starch content in the racetrack oval paperboard product.

Non-limiting, exemplary ranges of the amount of at least one modified starch in the backside additive include from 2% to 18% by weight, from 2% to 15% by weight, from 2% to 12% by weight, from 2% to 10% by weight, from 2% to 8% by weight, from 3% to 20% by weight, from 3% to 18% by weight, from 3% to 15% by weight, from 3% to 12% by weight, from 3% to 10% by weight, from 3% to 8% by weight, from 5% to 20% by weight, from 5% to 18% by weight, from 5% to 15% by weight, 5% to 12% by weight, from 5% to 10% by weight, from 5% to 8% by weight, from 7% to 20% by weight, from 7% to 18% by weight, from 7% to 15% by weight, from 7% to 12% by weight, from 7% to 10% by weight, from 10% to 20% by weight, and from 10% to 18% by weight, and from 10% to 15% by weight.

In these embodiments, the backside additive also comprises at least one crosslinker, and non-limiting examples of suitable crosslinkers include glyoxal crosslinkers, potassium zirconium crosslinkers, ammonia zirconium crosslinkers, citric acid crosslinkers, and combinations thereof. In embodiments wherein the backside additive comprises a glyoxal crosslinker, non-limiting, exemplary ranges of the amount of glyoxal crosslinker include from 0.5 to 6% dry weight of the starch, such as 0.5% to 5.5% by weight, 0.5% to 5% by weight, 0.5% to 4.5% by weight, 0.5% to 4% by weight, 0.5% to 3.5% by weight, 0.5% to 3% by weight, 0.5% to 2.5% by weight, 0.5% to 2% by weight, 1% to 5.5% by weight, 1% to 5% by weight, 1% to 4.5% by weight, 1% to 4% by weight, 1% to 3.5% by weight, 1% to 3% by weight, 1% to 2.5% by weight, 1.5% to 5.5% by weight, 1.5% to 5% by weight, 1.5% to 4.5% by weight, 1.5% to 4% by weight, 1.5% to 3.5% by weight, and 1.5% to 3% by weight. In embodiments when the backside additive comprises at least one zirconium and ammonia crosslinker, non-limiting, exemplary ranges of the amount of zirconium and ammonia crosslinkers include 0.5% to 5% by weight, 0.5% to 4.5% by weight, 0.5% to 4% by weight, 0.5% to 3.5% by weight, 0.5% to 3% by weight, 0.5% to 2.5% by weight, 0.5% to 2% by weight, 0.5% to 1.5%, by weight, 1% to 4.5% by weight, 1% to 4% by weight, 1% to 3.5% by weight, 1% to 3% by weight, 1% to 2.5% by weight, 1% to 2% by weight, 1.5% to 4.5% by weight, 1.5% to 4% by weight, 1.5% to 3.5% by weight, 1.5% to 3% by weight, 1.5% to 2.5% by weight, 2% to 4.5% by weight, 2% to 4% by weight, 2% to 3.5% by weight, 2% to 3% by weight, and 2% to 2.5% by weight.

In further embodiments, the backside additive comprises one of the following combinations: Ingredion™ PenCote™ L800 and a glyoxal crosslinker; Ingredion™ Redifilm™ 5800 and a glyoxal crosslinker; EcoSynthetix® EcoSphere® 2330 and a glyoxal crosslinker; Ingredion™ PenCote™ L800 and a potassium zirconium crosslinker; Ingredion™ Redifilm™ 5800 and a potassium zirconium crosslinker; and EcoSynthetix® EcoSphere® 2330 and a potassium zirconium crosslinker. It is contemplated that these combinations of modified starches and crosslinkers can be combined in any of the amounts disclosed above.

In more particular embodiments, the frontside of the racetrack oval paperboard product comprises a clearcoat. Non-limiting examples of clearcoats include water-based clearcoats such as aqueous dispersions of styrene-acrylic copolymers. Non-limiting examples include clearcoats produced by CA Coatings, such as Clear Aquavar™2044DE and Clear Aquavar™ 2120DE.

In further embodiments, the racetrack oval paperboard product has a coatings package comprising a backside additive and a frontside clearcoat. In these embodiments, the coated racetrack oval paperboard product comprises one of the following combinations:
a backside additive comprising Ingredion™ PenCote™ L800 and a glyoxal crosslinker, and Clear Aquavar™ 2044DE as the clearcoat;
a backside additive comprising Ingredion™ Redifilm™ 5800 and a glyoxal crosslinker, and Clear Aquavar™ 2044DE as the clearcoat;
a backside additive comprising EcoSynthetix® EcoSphere® 2330 and a glyoxal crosslinker, and Clear Aquavar™ 2044DE as the clearcoat;
a backside additive comprising Ingredion™ PenCote™ L800 and a potassium zirconium crosslinker, and Clear Aquavar™ 2120DE as the clearcoat;
a backside additive comprising Ingredion™ Redifilm™ 5800 and a potassium zirconium crosslinker, and Clear Aquavar™ 2120DE as the clearcoat; and
a backside additive comprising EcoSynthetix® EcoSphere® 2330 and a potassium zirconium crosslinker, and Clear Aquavar™ 2120DE as the clearcoat.

The backside additive according to the present disclosure may also contain additional components that may allow for at least one of higher-solids operations, greater dry rigidity, greater wet rigidity, and higher Consumer Acceptance Scores. Examples of such additional components include surfactants, plasticizers, humectants and combinations thereof.

In certain of the embodiments containing these coatings packages, the racetrack oval paperboard products have a rigidity value ranging from 375 to 500. Non-limiting, exemplary ranges include rigidity values of 400 to 500, 425 to 500, 450 to 500, 475 to 500, 375 to 475, 400 to 475, 425 to 475, 450 to 475, 375 to 450, 400 to 450, 425 to 450, 375 to 425, and 400 to 425. In additional embodiments, these rigidity values are produced in paper products formed from 18-point, 20-point, 22-point, and 24-point paper stock.

Additional embodiments are directed to an oval paperboard product comprising at least one modified starch and at least one crosslinker, wherein the oval paperboard product has a circular-shaped outer perimeter and further comprises: a substantially planar bottom region; a frustoconical sidewall extending upward and outward from an outer periphery of the bottom region; an annular inner brim portion contiguous with a radially outer extent of the frustoconical sidewall; and an annular outer frustoconical brim portion contiguous with a radially outer extent of the annular inner brim portion, wherein a first arcuate portion interconnects the bottom region and a radially inner end of the frustoconical sidewall, a second arcuate portion interconnects the radially outer extent of the frustoconical sidewall and the annular inner brim portion, and a third arcuate portion interconnects the radially outer extent of the annular inner brim portion and the annular outer frustoconical brim portion, the annular outer frustoconical brim portion includes a distal concave lip portion around an outer periphery of the product, the frustoconical sidewall extends upward and outward from the bottom region at an angle of 24.0±0.5 degrees from a vertical line parallel to a central axis of the product, the annular inner brim portion slopes downward and outward from the radially outer extent of the frustoconical sidewall at an angle that is 4.0±0.5 degrees from a horizontal line parallel to the bottom region, and the annular outer frustoconical brim portion slopes downward more steeply than the downward slope of the annular inner brim portion, extending from the radially outer extent of annular inner brim portion at an angle that is 40.0±0.5 degrees from the vertical line parallel to the central axis of the product.

The terminology “frustoconical” as used herein in connection with the profiles of paperboard plates or other paperboard products disclosed herein refers to an arcuate surface of rotation profile where it is seen that a sidewall of the container is either curved or frustoconical in shape or composed of combinations of these two shapes. In some cases, a container may be formed by combining portions of several surfaces of rotation as in the case of ovals or other non-circular shapes.

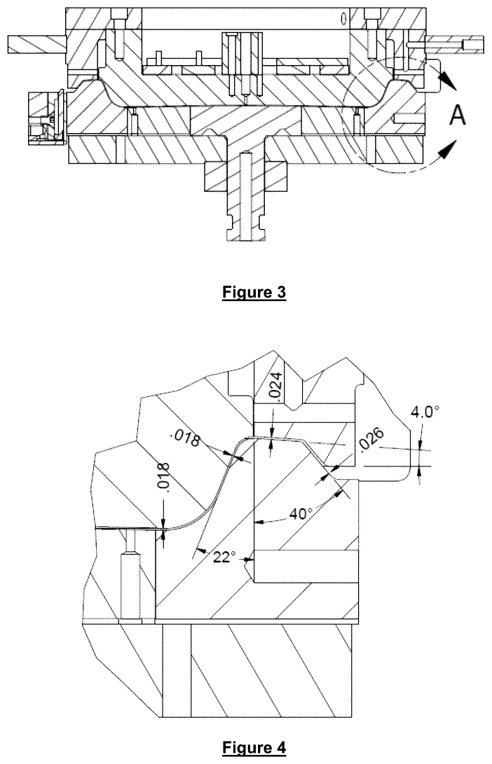

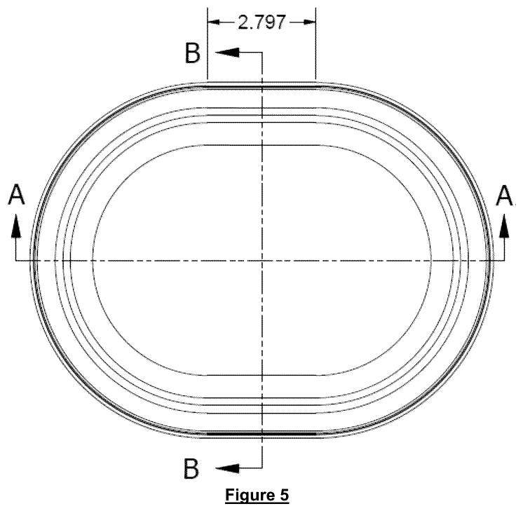

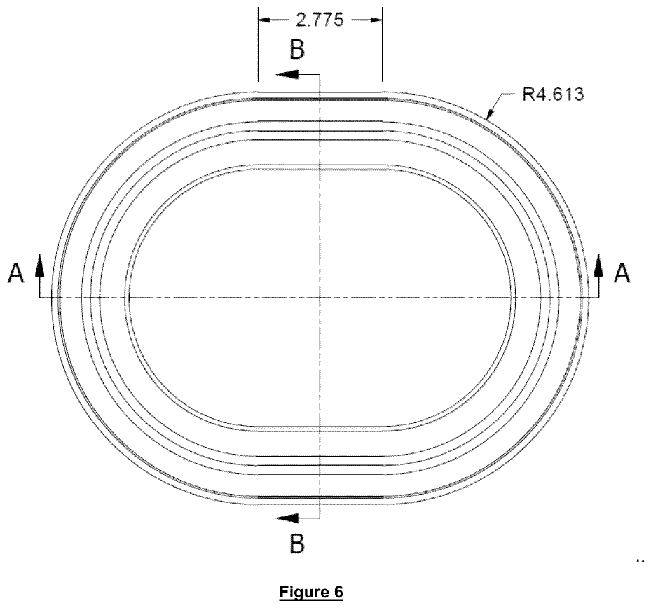

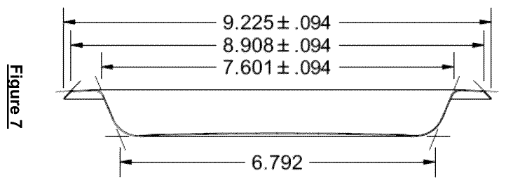

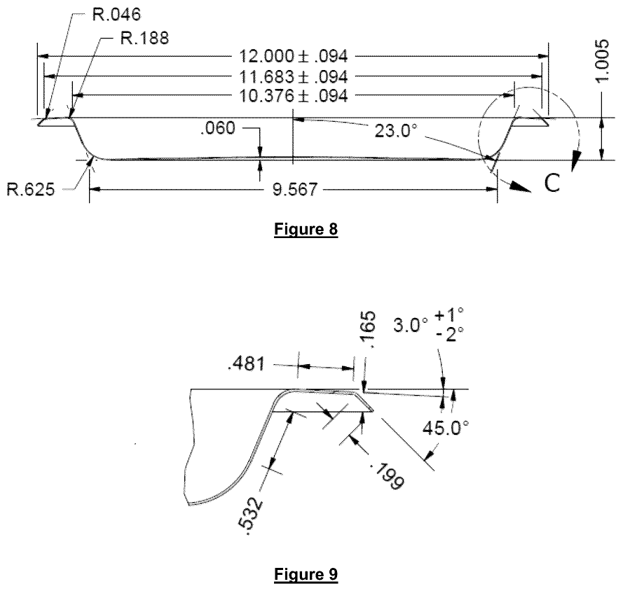

FIG. 3 depicts an enlarged cross-sectional profile of portions of exemplary embodiments of dies that may be used in forming the racetrack oval plates according to the present disclosure. The bottom region and frustoconical sidewall of the racetrack oval plate may be pressed to a thickness of 0.018 inch (18 pt.) while the annular inner brim portion may be pressed to a thickness of 0.024 inch, and annular outer frustoconical brim portion may be pressed to a thickness of 0.026 inch.

In this exemplary embodiment of the racetrack oval plate the frustoconical sidewall extends upward and outward from substantially planar bottom region at an angle of 22.0±0.5 degrees from a vertical line parallel to a central axis of the plate. The annular inner brim portion may slope downward and outward from the radially outer extent of frustoconical sidewall at an angle that is 4.0±0.5 degrees from a horizontal line parallel to bottom region. The annular outer frustoconical brim portion may slope downward more steeply than the downward slope of annular inner brim portion, extending from the radially outer extent of annular inner brim portion at an angle that is 40.0±0.5 degrees from the vertical line parallel to the central axis of plate.

Additionally, in certain embodiments, the substantially planar bottom region has a thickness of 0.018±0.0005 inch, the frustoconical sidewall has a thickness of 0.018±0.0005 inch, the annular inner brim portion has a thickness of 0.024±0.0005 inch, and the annular outer frustoconical brim portion has a thickness of 0.026±0.0005 inch.

Additional embodiments of the present disclosure are directed to process for making a rigid paperboard product, the process comprising: a) providing a paperboard material to a die press in a plate former; b) applying pressure to the plate former in an amount ranging from four tons to eleven tons; c) applying a backside coating to the formed plate using a press coater, wherein the backside coating comprises at least one modified starch in an amount ranging from 2% to 20% by weight of the paperboard product, and at least one crosslinker in an amount ranging from 0.5% to 8% by weight based on the dry weight of the starch content in the paperboard product.

Based on the die designs according to the present disclosure, the plate formers can run at a temperature ranging from 350° F. to 475° F., and non-limiting exemplary temperature ranges include from 400-475° F., from 425-475° F., from 375-450° F., from 400-450° F., and from 375-425° F. In certain embodiments, the plate formers are run at a temperature chosen from 375° F., 380° F., 390° F., 400° F., 410° F., 420° F., and 425° F. High temperatures can also result in more forced deterioration of wear parts on the plate former machinery, including expensive cam roller surfaces and bearings.

In certain embodiments, the plate former can run at a rate of 32 to 50 strokes per minutes. Non-limiting exemplary ranges include from 32 to 48 strokes per minute, from 32 to 44 strokes per minute, from 32 to 40 strokes per minute, from 32 to 38 strokes per minute, from 32 to 36 strokes per minute, from 34 to 48 strokes per minute, from 34 to 44 strokes per minute, from 34 to 40 strokes per minute, from 34 to 36 strokes per minute, from 36 to 44 strokes per minute, from 34 to 40 strokes per minute, from 34 to 38 strokes per minute, from 36 to 48 strokes per minute, from 36 to 44 strokes per minute, and from 36 to 40 strokes per minute. In certain embodiments, the plate former can run at a rate of from 34 to 38 strokes per minute at a temperature ranging from 375-425° F. In a further embodiment of the present disclosure, the plate former can run at a rate of from 36 strokes per minute at a temperature of 400° F.

The dwell time in the die can be dependent on the run rate of the plate former. In certain embodiments, the dwell time of the paperboard material in the paper former die can range from 0.40 seconds to 1.0 seconds per formed plate. Non-limiting exemplary dwell-time ranges include from 0.40 to 0.90 seconds, from 0.44 to 0.86 seconds, from 0.48 to 0.82 seconds, from 0.52 to 0.78 seconds, from 0.56 to 0.74 seconds, from 0.60 to 0.70 seconds, and from 0.64 to 0.68 seconds. In an additional embodiment of the present disclosure, the dwell time of the paperboard material in the paper former is 0.66 seconds.

The number of springs used in the plate formers can be varied to adjust the pressure applied to the dies in the plate former, and each spring applies one ton of pressure to the die. Certain embodiments of the present disclosure are directed to applying four tons to eleven tons of pressure on the dies in the plate former. Non-limiting, exemplary amounts of pressure that can be applied to the plate-forming die include from four to ten tons, four to eight tons, from four to six tons, four tons, five tons, six tons, seven tons, eight tons, nine tons, ten tons, and eleven tons. In certain embodiments, it may be desirable to operate the plate former under higher pressure to produce more rigid, lower fiber-containing paperboard products, while accepting a potentially higher cost of planned and scheduled maintenance.

### EXAMPLES

### Plate Performance Assessment

Four focus groups were conducted to provide feedback on 20-point racetrack oval plates made using the new die design according to the present disclosure. All groups were 2 hours in length and were comprised of Walmart customers who purchase heavyweight oval disposable paper plates with a design or decoration at Walmart. Each focus group was comprised of seven to eight respondents and the four groups totaled 31 respondents.

Respondents were asked to carry the new Racetrack Oval 20 pt. plate to a buffet table, fill the plate with food (salad, spaghetti with sauce and meat balls), carry the full plate back to the table, and use cutlery in the manner they would normally. They were then asked to evaluate the Racetrack Oval 20 pt. plate on overall performance and four important criteria: Rim/Edge Strength, Food Holding Capacity, Leakproof, Cut Resistance.

After usage, the new Racetrack Oval 20 pt. plate was deemed as good as or better than other oval heavy weight disposable paper plates respondents have purchased/used on all criteria assessed as set forth in Table 1.

TABLE 1

| | Racetrack Oval Total | | | | |
|---|---|---|---|---|---|
| | | Rim/Edge | Food Holding | | |
| | | Strength | Capacity | | |
| | | (security & | (strong enough to | | Cut |
| | | comfort when | hold/carry heavy | | Resistant |
| | | holding the plate | or abundant food | Leakproof | (stands |
| | Overall | that it will not | without bending/ | (liquids won't | up to |
| | Performance | spill) | buckling) | seep through) | cutlery) |
| As Good As Or Better | 30 | 31 | 31 | 28 | 28 |
| Much Better | 12 | 16 | 11 | 11 | 12 |
| Than Other Decorated | | | | | |
| Heavy Weight Oval Paper | | | | | |
| Plates I Have Purchased/ | | | | | |
| Used | | | | | |
| Slightly Better | 15 | 9 | 15 | 7 | 12 |
| As Good As | 3 | 6 | 5 | 10 | 4 |
| Slightly Worse | 1 | 0 | 0 | 3 | 2 |
| Much Worse | | | | | |
| Than Other Decorated Heavy | 0 | 0 | 0 | 0 | 1 |
| Weight Oval Paper Plates I | | | | | |
| Have Purchased | | | | | |

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A racetrack oval paperboard product comprising two straight sidewalls parallel to one another in the longitudinal direction of the product, the racetrack oval paperboard products further comprising at least one modified starch and at least one crosslinker,
wherein the at least one modified starch is present in an amount ranging from 2% to 20% by weight of the oval paperboard product,
wherein the at least one crosslinker is present in an amount ranging from 0.5% to 8% by weight based on a dry weight of the starch content in the oval paperboard product, and
wherein the racetrack oval paperboard product has a rigidity value ranging from 375 to 500.

2. The racetrack oval paperboard product according to claim 1, wherein the at least modified starch is a highly branched amylopectin present in an amount ranging from 10 to 20% based on the weight of the paperboard product.

3. The racetrack oval paperboard product according to claim 1, where the at least one crosslinker is chosen from glyoxal crosslinkers, potassium zirconium crosslinkers, ammonia zirconium crosslinkers, citric acid crosslinkers.

4. The racetrack oval paperboard product according to claim 3, wherein the at least one crosslinker is present in an amount ranging from 0.5 to 6% based on the weight of the paperboard product.

5. The racetrack oval paperboard product according to claim 1, wherein the product is a 9.2″×12″ oval plate, and wherein the plate has a thickness ranging from 18 points to 24 points.

6. The racetrack oval paperboard product according to claim 1, wherein the racetrack oval paperboard product has a straight sidewall length ranging from 2.7±0.3 inches.

7. A racetrack oval paperboard product comprising at least one modified starch and at least one crosslinker, wherein the paperboard product has two straight sides parallel to one another separated by two semicircular curved ends and further comprises:
a substantially planar bottom region;
a substantially frustoconical sidewall extending upward and outward from an outer periphery of the bottom region;
an annular inner brim portion contiguous with a radially outer extent of the frustoconical sidewall; and
an annular outer frustoconical brim portion contiguous with a radially outer extent of the annular inner brim portion, wherein
a first arcuate portion interconnects the bottom region and a radially inner end of the frustoconical sidewall, a second arcuate portion interconnects the radially outer extent of the frustoconical sidewall and the annular inner brim portion, and a third arcuate portion interconnects the radially outer extent of the annular inner brim portion and the annular outer frustoconical brim portion,
the annular outer frustoconical brim portion includes a distal concave lip portion around an outer periphery of the product,
the frustoconical sidewall extends upward and outward from the bottom region at an angle of 22.0±0.5 degrees from a vertical line parallel to a central axis of the product,
the annular inner brim portion slopes downward and outward from the radially outer extent of the frustoconical sidewall at an angle that is 4.0±0.5 degrees from a horizontal line parallel to the bottom region, and
the annular outer frustoconical brim portion slopes downward more steeply than the downward slope of the annular inner brim portion, extending from the radially outer extent of annular inner brim portion at an angle that is 40.0±0.5 degrees from the vertical line parallel to the central axis of the product.

8. The racetrack oval paperboard product according to claim 7, wherein the substantially planar bottom region has a thickness of 0.018±0.0005 inch, the frustoconical sidewall has a thickness of 0.018±0.0005 inch, the annular inner brim portion has a thickness of 0.024±0.0005 inch, and the annular outer frustoconical brim portion has a thickness of 0.026±0.0005 inch.

9. The racetrack oval paperboard product according to claim 7, wherein the product is a 9.2″×12″ racetrack oval plate.

10. The racetrack oval paperboard product according to claim 9, wherein the racetrack oval plate has a straight sidewall length ranging from 2.7±0.3 inches.
